(19) United States
(12) Patent Application Publication
(10) Pub. No.: US 2022/0395912 A1
(43) Pub. Date: Dec. 15, 2022

(54) Pipe Tool Device

(71) Applicant: David Hothan, Oroville, CA (US)

(72) Inventor: David Hothan, Oroville, CA (US)

(21) Appl. No.: 17/830,772

(22) Filed: Jun. 2, 2022

Related U.S. Application Data
(60) Provisional application No. 63/208,555, filed on Jun. 9, 2021.

(51) Int. Cl. B23B 31/12

(52) U.S. Cl. CPC B23B 31/123; B23B 31/1215; B23B 2231/06

(57) ABSTRACT

The present invention relates to a novel pipe tool device. The device comprises a drill attachment which can be secured to any type of standard impact or drill gun capable of tightening or loosening PVC and threaded pipes of varying sizes. The drill attachment comprises a gap ring and a slip die which allows the drill attachment to tighten or loosen piping. The drill attachment can be connected to any standard drill bit attachment and activated in a clockwise or counterclockwise direction for tightening or loosening applications. The pipe tool device rotates open and closed and includes a support beam on the drill. Further, a second drill attachment can be provided, which functions as a pipe cutter.

### CROSS-REFERENCE TO RELATED APPLICATION

The present application claims priority to, and the benefit of, U.S. Provisional Application No. 63/208,555, which was filed on Jun. 9, 2021, and is incorporated herein by reference in its entirety.

### FIELD OF THE INVENTION

The present invention relates generally to the field of pipe tools. More specifically, the present invention relates to an improved pipe tool device that provides users with a drill attachment to loosen or tighten pipes. Accordingly, the present disclosure makes specific reference thereto. Nonetheless, it is to be appreciated that aspects of the present invention are also equally applicable to other like applications, devices and methods of manufacture.

### BACKGROUND

By way of background, tightening and loosening pipes can be a difficult and frustrating task, especially with pipes in tight spaces and other hard to reach areas. Further, pipes that slip during the tightening or loosening process can be dangerous and cause injury. Trying to remove or apply a pipe can cause stress on the body, and overall, the process can take a considerable amount of time. Thus, devices for tightening and/or loosening hard-to-reach pipes can be advantageous.

Additionally, as a result of considerable developments within the field of power tools and the increased demand of the DIY market, the number of different types of power tools available to the consumer has risen considerably in the past decade. Whilst this considerable array of power tools is often found to be useful, owning such a large number is both expensive and requires a considerable amount of storage space. Accordingly, a need exists for an inexpensive, versatile, and easily operated driver attachment for a drill.

Therefore, there exists a long-felt need in the art for a pipe tool device that provides users with a unique drill attachment to loosen or tighten pipes to make a job much easier and faster. There is also a long-felt need in the art for a pipe tool device that prevents users from having to manually apply a tool to a pipe, which can be especially difficult in tight spaces. Further, there is a long-felt need in the art for a pipe tool device that allows users to attach the device to a drill like a conventional drill bit for tightening or loosening a PVC or threaded pipe. Moreover, there is a long-felt need in the art for a device that utilizes a gap ring and slip die in combination to tighten or loosen piping with a simple application. Further, there is a long-felt need in the art for a pipe tool device that saves time and effort when tightening and/or loosening hard-to-reach pipes. Finally, there is a long-felt need in the art for a pipe tool device that includes an alternate version that provides a drill attachment that functions as a pipe cutter.

The subject matter disclosed and claimed herein, in one embodiment thereof, comprises a pipe tool device. The device is designed to save time and effort when loosening and/or tightening hard-to-reach pipes. The device comprises a drill attachment which can be secured to any type of standard impact or drill gun capable of tightening or loosening PVC and threaded pipes of varying sizes. The drill attachment comprises a gap ring and a slip die which allows the drill attachment to tighten or loosen piping. The drill attachment can be connected to any standard drill bit attachment and activated in a clockwise or counterclockwise direction for tightening or loosening applications. The pipe tool device rotates open and closed and includes a support beam on the drill. Further, a second drill attachment can be provided which functions as a pipe cutter. Additionally, a heavy-duty drill with a backup attachment can be provided as an accessory.

In this manner, the pipe tool device of the present invention accomplishes all of the foregoing objectives and provides users with a device that secures to a conventional drill bit for tightening or loosening a threaded pipe. The device allows a user to avoid manually tightening and/or loosening a threaded pipe in tight spaces. The device saves time and effort when trying to remove or apply a threaded pipe.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pipe tool device. The device comprises a drill attachment which can be secured to any type of standard impact or drill gun capable of tightening or loosening PVC and threaded pipes of varying sizes. The drill attachment comprises a gap ring and a slip die which allows the drill attachment to tighten or loosen piping. The drill attachment can be connected to any standard drill bit attachment and activated in a clockwise or counterclockwise direction for tightening or loosening applications.

In one embodiment, the pipe tool device is configured to be used with a conventional drill, or any other suitable power tool, as is known in the art, such as a standard drill, an impact drill, or a drill gun, etc. The drill can be powered via batteries or electrical cord, or any other suitable means for powering a conventional drill as is known in the art. The drill comprises a drill chuck component for accepting conventional drill bit shafts or driver shafts. Specifically, the drill chuck component opens and closes, securing the drill bit shaft within the drill chuck component via a chuck key or other suitable securing means as is known in the art.

In another embodiment, the pipe tool device comprises a drill bit shaft connected to a slip die component. The slip die component acts to secure onto the pipe to be loosened and/or tightened. Any suitable pipe or size of pipe as is known in the art can be utilized with the device, depending on the needs and/or wants of a user, such as a PVC pipe, a threaded pipe, a galvanized pipe, etc. The slip die component comprises at least three sidewalls configured in a C-shape, with an opening for receiving the pipe to be tightened/loosened. Any suitable shape of the slip die component can be utilized as is known in the art, as long as the slip die component comprises an opening for receiving the pipe and comprises at least three sidewalls for wrapping around a perimeter of the pipe to secure the pipe within the slip die component. Typically, the slip die component is configured into such a shape that the diameter of the opening is slightly smaller than diameter of the pipe, such that the slip die component is press-fit onto the pipe. Further, slip die components can be configured in multiple sizes to be able to secure around different sizes of pipes.

In yet another embodiment, the pipe tool device comprises a plurality of gear components housed within the slip die component. The plurality of gear components act to provide tangential rotation capable of tightening or loosening the pipe. Specifically, the drill bit shaft engages the gear components within the slip die component to provide clockwise and/or counterclockwise rotation. Thus, the device rotates open and closed. In operation, the drill powers the drill bit shaft to rotate in a clockwise and/or counterclockwise direction. Then, the drill bit shaft engages the gear components housed within the slip die component to provide clockwise and/or counterclockwise rotation of the slip die component, tangential to rotation of the drill bit shaft, allowing the slip die component to tighten and/or loosen the pipe its secured around.

In another embodiment, the pipe tool device comprises a gap ring component positioned on an interior of the sidewalls of the slip die component, such that the gap ring component contacts the pipe to be tightened and/or loosened. The gap ring component is typically a pliable component that acts to grab the pipe and create a cushion or gripping means for contacting the pipe and securing the slip die component to the pipe. The gap ring components also engage the plurality of gear components within the slip die component to create rotation. Thus, the gap ring components rotate counterclockwise and/or clockwise to tighten or loosen the pipe.

In another embodiment, the pipe tool device comprises a support beam component. The support beam component can be any suitable size and shape as is known in the art, depending on the needs and/or wants of a user. The support beam component is secured from the drill to the slip die component via any suitable securing means as is known in the art, such as screws, pins, press fit, etc. The support beam component acts as a counter torque to prevent the slip die component from rotating. Thus, restriction of movement from the slip die component ensures that the plurality of gears within the slip die component engage the gap ring components to rotate clockwise and/or counterclockwise, tightening and/or loosening the pipe.

In another embodiment, the pipe tool device comprises a release trigger. The release trigger is positioned on the slip die component in any suitable place as is known in the art. The release trigger acts to push the device off of the pipe it is secured to. If the user needs to reposition the device on the pipe, or is done tightening/loosening the pipe, a user pulls the release trigger to release the device from the pipe. Typically, the release trigger would engage a lever or other suitable means to contact the pipe, pushing the device off of the pipe.

In another embodiment, the device comprises a backup attachment insert slot or receptacle. The backup attachment insert slot or receptacle is positioned on the body of the drill, in any suitable position as is known in the art. The backup attachment insert slot or receptacle acts to accept a backup pipe tool device. The backup pipe tool device is secured within the insert slot for later use and/or as a backup if the first pipe tool device breaks or does not fit the pipe needing to be tightened or loosened.

In another embodiment, the device comprises a slip die component comprising a plurality of circular blades instead of the gap ring components. Any suitable blades can be utilized as is known in the art, depending on the needs and/or wants of a user. The plurality of circular blades allow the device to act as a pipe cutting tool. The device secures to the pipe at interest and instead of loosening/tightening the pipe, the device cuts the pipe via the plurality of circular blades.

In another embodiment, the pipe tool device comprises a plurality of indicia on the slip die component and/or other components of the device.

In yet another embodiment, the pipe tool device is manufactured from any suitable metal as is known in the art, such as aluminum, stainless steel, tool steel, or powder-coated metals, etc.

In yet another embodiment, a method of tightening or loosening a pipe in a tight space is described. The method includes the steps of providing a pipe tool device comprising a drill attachment with a gap ring and slip die to allow for tightening or loosening of hard-to-reach piping. The method also comprises securing the pipe tool device to a standard drill. Further, the method comprises securing the slip die of the device to the pipe to be tightened and/or loosened. Further, once secured, the method comprises activating the device via the drill, such that the device rotates in a clockwise or counterclockwise direction for tightening or loosening applications. Finally, utilizing a pipe cutter function of the device to cut a pipe.

In yet another embodiment of the present invention, a pipe tool device is disclosed for loosening and/or tightening a pipe. The device comprises a drill attachment secured to a standard drill. The drill attachment comprises a slip die component and a gap ring component which allows the drill attachment to secure to a pipe. Rotation of the drill engages a plurality of gears within the slip die component to cause rotation of the gap ring component, which tightens and/or loosens the pipe. In another embodiment, the device secures to a pipe and cuts the pipe, instead of tightening and/or loosening the pipe.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the pipe tool device of the present invention in accordance with the disclosed architecture;

FIG. 2 illustrates a perspective view of one potential embodiment of the pipe tool device of the present invention secured to a drill in accordance with the disclosed architecture;

FIG. 3 illustrates a perspective view of one potential embodiment of the pipe tool device of the present invention used as a pipe cutter in accordance with the disclosed architecture; and

FIG. 4 illustrates a flowchart showing the method of tightening or loosening a pipe in a tight space utilizing one potential embodiment of the pipe tool device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a pipe tool device that provides users with a unique drill attachment to loosen or tighten pipes to make a job much easier and faster. There is also a long-felt need in the art for a pipe tool device that prevents users from having to manually apply a tool to a pipe which can be especially difficult in tight spaces. Further, there is a long-felt need in the art for a pipe tool device that allows users to attach the device to a drill like a conventional drill bit for tightening or loosening a PVC or threaded pipe. Moreover, there is a long-felt need in the art for a device that utilizes a gap ring and slip die in combination to tighten or loosen piping with a simple application. Further, there is a long-felt need in the art for a pipe tool device that saves time and effort when tightening and/or loosening hard-to-reach pipes. Finally, there is a long-felt need in the art for a pipe tool device that includes an alternate version that provides a drill attachment that functions as a pipe cutter.

The present invention, in one exemplary embodiment, is a novel pipe tool device. The device comprises a drill attachment which can be secured to any type of standard impact or drill gun capable of tightening or loosening PVC and threaded pipes of varying sizes. The drill attachment comprises a gap ring and a slip die which allows the drill attachment to tighten or loosen piping. Further, a second drill attachment can be provided, which functions as a pipe cutter. The present invention also includes a novel method of tightening or loosening a pipe in a tight space. The method includes the steps of providing a pipe tool device comprising a drill attachment with a gap ring and slip die to allow for tightening or loosening of hard-to-reach piping. The method also comprises securing the pipe tool device to a standard drill. Further, the method comprises activating the device via the drill, such that the device rotates in a clockwise or counterclockwise direction for tightening or loosening applications. Finally, utilizing a pipe cutter function of the device to cut a pipe.

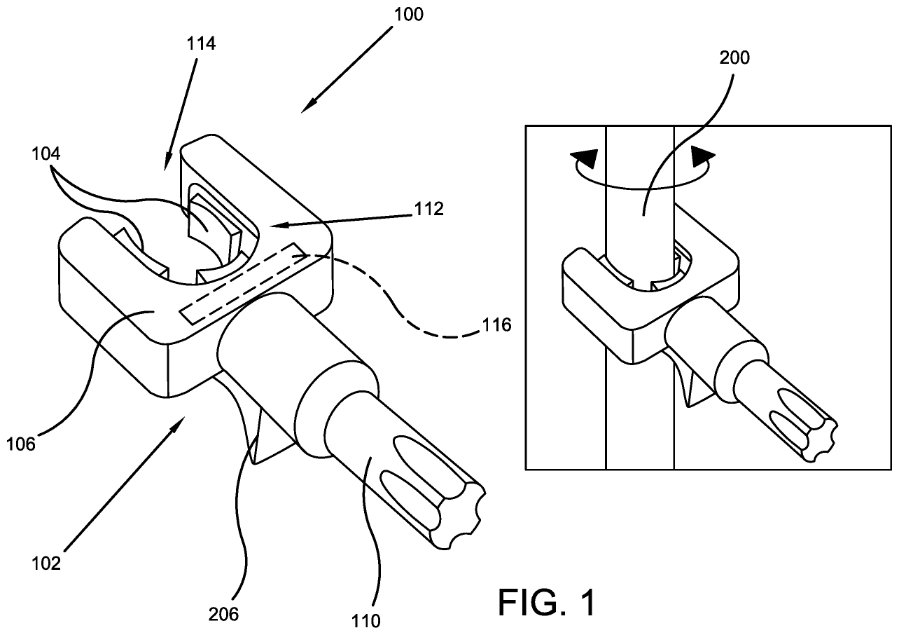

Referring initially to the drawings, FIG. 1 illustrates a perspective view of one embodiment of the pipe tool device 100 of the present invention. In the present embodiment, the pipe tool device 100 is an improved pipe tool device that provides for quick and easy loosening and/or tightening of hard-to-reach pipes. The device 100 is especially designed to allow any skilled worker or laborer for commercial or personal use, etc., or any other suitable user as is known in the art, to easily tighten or loosen pipes in tight areas. More specifically, the device 100 comprises a drill attachment component 102 comprising a gap ring component 104 and a slip die component 106 for securing to a pipe 200 and allowing the user to tighten and/or loosen the pipe 200.

The pipe tool device 100 is configured to be used with a conventional drill 202, or any other suitable power tool, as is known in the art, such as a standard drill, an impact drill or a drill gun, etc. The drill 202 can be powered via batteries or electrical cord, or any other suitable means for powering a conventional drill as is known in the art. The drill 202 can be any suitable size as is known in the art, such as ⅜^{th} or ¼^{th}, etc. The drill 202 comprises a drill chuck component 108 for accepting conventional drill bit shafts or driver shafts. Specifically, the drill chuck component 108 opens and closes, securing the drill bit shaft 110 within the drill chuck component 108 via a chuck key or other suitable securing means as is known in the art.

Furthermore, the pipe tool device 100 comprises a drill bit shaft 110 connected to a slip die component 106. The slip die component 106 acts to secure onto the pipe 200 to be loosened and/or tightened. Any suitable pipe 200 or size of pipe 200 as is known in the art can be utilized with the device 100 depending on the needs and/or wants of a user, such as a PVC pipe, a threaded pipe, a galvanized pipe, etc. The slip die component 106 comprises at least three sidewalls 112 configured in a C-shape, with an opening 114 for receiving the pipe 200 to be tightened/loosened. Any suitable shape of the slip die component 106 can be utilized as is known in the art, as long as the slip die component 106 comprises an opening 114 for receiving the pipe 200 and comprises at least three sidewalls 112 for wrapping around a perimeter of the pipe 200 to secure the pipe 200 within the slip die component 106. Typically, the slip die component 106 is configured into such a shape that the diameter of the opening 114 is slightly smaller than diameter of the pipe 200, such that the slip die component 106 is press-fit onto the pipe 200. Further, slip die components 106 can be configured in multiple sizes to be able to secure around different sizes of pipes 200.

Additionally, the pipe tool device 100 comprises a plurality of gear components 116 housed within the slip die component 106. The plurality of gear components 116 act to provide tangential rotation capable of tightening or loosening the pipe 200. Specifically, the drill bit shaft 110 engages the gear components 116 within the slip die component 106 to provide clockwise and/or counterclockwise rotation. Thus, the device 100 rotates open and closed. In operation, the drill 202 powers the drill bit shaft 110 to rotate in a clockwise and/or counterclockwise direction. Then, the drill bit shaft 110 engages the gear components 116 housed within the slip die component 106 to provide clockwise and/or counterclockwise rotation of the slip die component 106, tangential to rotation of the drill bit shaft 110, allowing the slip die component 106 to tighten and/or loosen the pipe 200 its secured around.

Furthermore, the pipe tool device 100 comprises a gap ring component 104 positioned on an interior of the sidewalls 112 of the slip die component 106, such that the gap ring component 104 contacts the pipe 200 to be tightened and/or loosened. The gap ring component 104 is typically a pliable component that acts to grab the pipe 200 and create a cushion or gripping means for contacting the pipe 200 and securing the slip die component 106 to the pipe 200. The gap ring component 104 can be manufactured of any suitable malleable materials as is known in the art, depending on the needs and/or wants of a user. The gap ring components 104 also engage the plurality of gear components 116 within the slip die component 106 to create rotation. Thus, the gap ring components 104 rotate counterclockwise and/or clockwise to tighten or loosen the pipe 200.

In another embodiment, the pipe tool device 100 comprises a release trigger 206. The release trigger 206 can be any suitable size and shape as is known in the art, and is positioned on the slip die component 106 in any suitable place as is known in the art. The release trigger 206 acts to push the device 100 off of the pipe 200 it is secured to. If the user needs to reposition the device 100 on the pipe 200, or is done tightening/loosening the pipe 200, a user pulls the release trigger 206 to release the device 100 from the pipe 200. Typically, the release trigger 206 would engage a lever or other suitable means (not shown) to contact the pipe 200, pushing the device 100 off of the pipe 200.

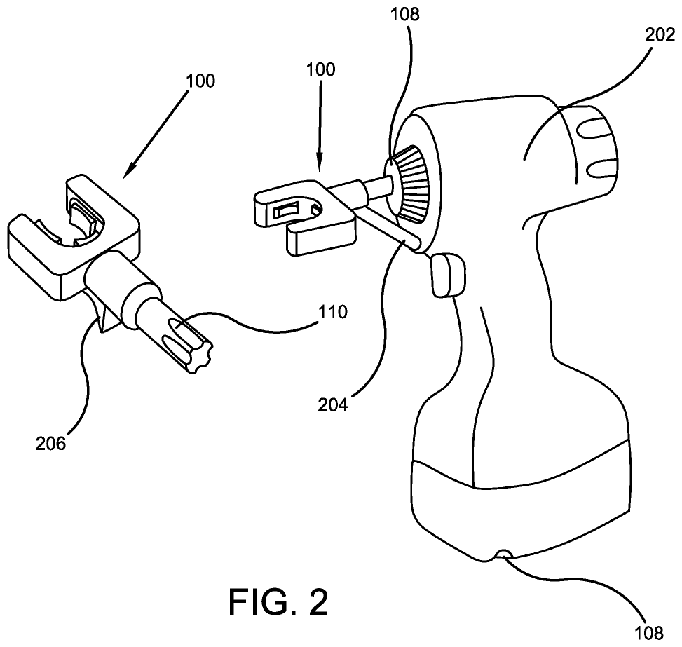

FIG. 2 illustrates a perspective view of another embodiment of the pipe tool device 100 of the present invention. In this embodiment, the pipe tool device 100 comprises a support beam component 204. The support beam component 204 can be any suitable size and shape as is known in the art, depending on the needs and/or wants of a user. The support beam component 204 is secured from the drill 202 to the slip die component 106 via any suitable securing means as is known in the art, such as screws, pins, press fit, etc. The support beam component 204 acts as a counter torque to prevent the slip die component 106 from rotating. Thus, restriction of movement from the slip die component 106 ensures that the plurality of gears 116 within the slip die component 106 engage the gap ring components 104 to rotate clockwise and/or counterclockwise, tightening and/or loosening the pipe 200.

Further, the device 100 comprises a backup attachment insert slot or receptacle 208. The backup attachment insert slot or receptacle 208 is positioned on the body of the drill 202 in any suitable position as is known in the art. The backup attachment insert slot or receptacle 208 acts to accept a backup pipe tool device 100. The backup pipe tool device 100 is secured within the insert slot 208 for later use and/or as a backup if the first pipe tool device 100 breaks or does not fit the size of pipe 200 needing to be tightened or loosened.

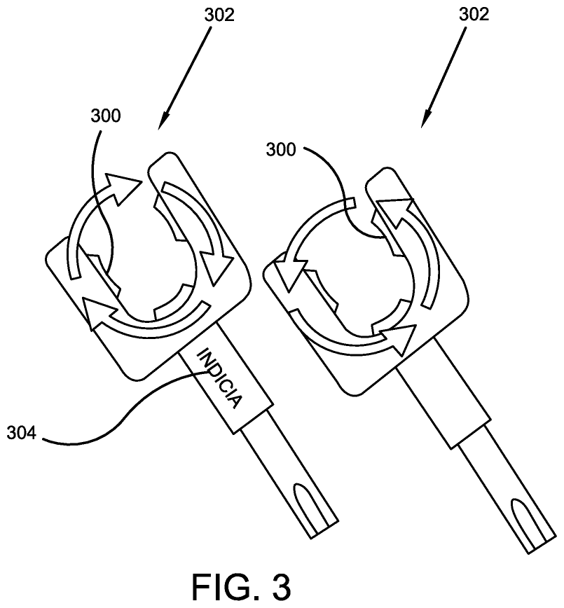

FIG. 3 illustrates a perspective view of another embodiment of the pipe tool device 100 of the present invention. In this embodiment, the device 100 comprises a slip die component 106 comprising a plurality of circular blades 300 instead of the gap ring components 104. Any suitable blades 300 can be utilized as is known in the art, depending on the needs and/or wants of a user. The plurality of circular blades 300 allow the device 100 to act as a pipe cutting tool 302. The device 100 secures to the pipe 200 at interest and instead of loosening/tightening the pipe 200, the device 100 cuts the pipe 200 via the plurality of circular blades 300.

In another embodiment, the pipe tool device 100 comprises a plurality of indicia 304 on the slip die component 106 and/or other components of the device 100. Specifically, the slip die component 106 of the pipe tool device 100 may include advertising, a trademark, or other letters, designs, or characters, printed, painted, stamped, or integrated into the slip die component 106, or any other indicia 304 as is known in the art. Specifically, any suitable indicia 304 as is known in the art can be included, such as but not limited to, patterns, logos, emblems, images, symbols, designs, letters, words, characters, animals, advertisements, brands, etc., that may or may not be pipe or brand related.

In yet another embodiment, the pipe tool device 100 is manufactured from any suitable metals as is known in the art, such as aluminum, stainless steel, tool steel, or powder-coated metals, etc., depending on the needs and/or wants of a user.

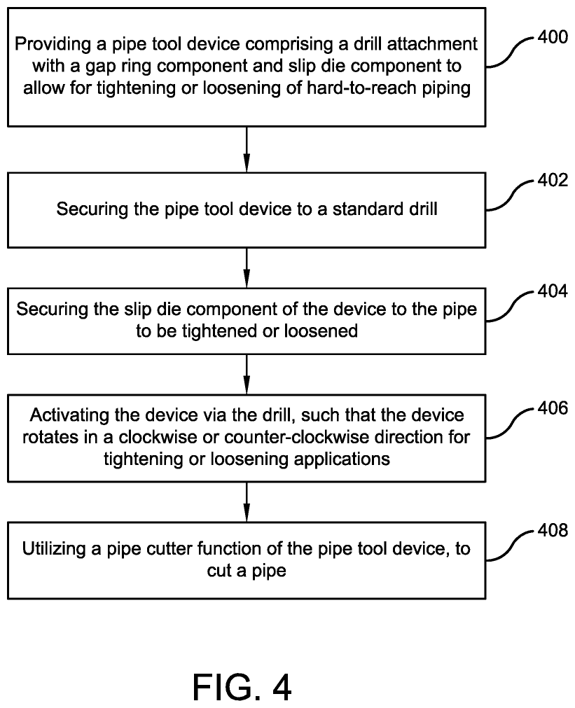

FIG. 4 illustrates a flowchart of the method of tightening or loosening a pipe in a tight space. The method includes the steps of at 400, providing a pipe tool device comprising a drill attachment with a gap ring and slip die to allow for tightening or loosening of hard-to-reach piping. The method also comprises at 402, securing the pipe tool device to a standard drill. Further, the method comprises at 404, securing the slip die of the device to the pipe to be tightened and/or loosened. Further, once secured, the method comprises at 406, activating the device via the drill, such that the device rotates in a clockwise or counterclockwise direction for tightening or loosening applications. Finally, at 408, utilizing a pipe cutter function of the device, to cut a pipe.

In yet another embodiment of the present invention, a pipe tool device 100 is disclosed for loosening and/or tightening a pipe 200. The device 100 comprises a drill attachment component 102 secured to a standard drill 202. The drill attachment component 102 comprises a slip die component 106 and a gap ring component 104 which allows the drill attachment component 102 to secure to a pipe 200. Rotation of the drill 202 engages a plurality of gears 116 within the slip die component 106 to cause rotation of the gap ring component 104, which tightens and/or loosens the pipe 200. In another embodiment, the device 100 secures to a pipe 200 and cuts the pipe 200, instead of tightening and/or loosening the pipe 200.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “pipe tool device” and “device” are interchangeable and refer to the pipe tool device 100 of the present invention.

Notwithstanding the foregoing, the pipe tool device 100 of the present invention can be of any suitable size and configuration as is known in the art without affecting the overall concept of the invention, provided that it accomplishes the above-stated objectives. One of ordinary skill in the art will appreciate that the pipe tool device 100 as shown in FIGS. 1-4 is for illustrative purposes only, and that many other sizes and shapes of the pipe tool device 100 are well within the scope of the present disclosure. Although the dimensions of the pipe tool device 100 are important design parameters for user convenience, the pipe tool device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pipe tool device for loosening or tightening a hard-to-reach pipe, the pipe tool device comprising:
a drill attachment component comprising a gap ring component and a slip die component; and
a drill bit shaft secured to the drill attachment component;
wherein the drill attachment component is secured to a drill via the drill bit shaft;
wherein the slip die component is secured around the hard-to-reach pipe; and
further wherein the pipe tool device provides a clockwise or counterclockwise rotation of the slip die component, which is tangential to a rotation of the drill bit shaft, thereby allowing the slip die component to tighten or loosen the hard-to-reach pipe its secured around.

2. The pipe tool device of claim 1, wherein the drill comprises a drill chuck component for accepting the drill bit shaft.

3. The pipe tool device of claim 2, wherein the slip die component comprises at least three sidewalls, configured in a C-shape.

4. The pipe tool device of claim 3, wherein the slip die component comprises an opening for receiving the hard-to-reach pipe.

5. The pipe tool device of claim 4, wherein the slip die component comprises a plurality of gear components, which provide tangential rotation capable of tightening or loosening the hard-to-reach pipe.

6. The pipe tool device of claim 5, wherein the gap ring component is positioned on an interior of the at least three sidewalls of the slip die component.

7. The pipe tool device of claim 6, wherein the gap ring component acts to secure the slip die component to the hard-to-reach pipe.

8. The pipe tool device of claim 7, wherein the gap ring component engages the plurality of gear components within the slip die component to create rotation.

9. The pipe tool device of claim 8, wherein the gap ring component rotates counterclockwise or clockwise to tighten or loosen the hard-to-reach pipe.

10. The pipe tool device of claim 1 further comprising a release trigger for releasing the pipe tool device from the hard-to-reach pipe.

11. The pipe tool device of claim 1 further comprising a support beam component.

12. The pipe tool device of claim 1 further comprising a backup attachment insert slot for accepting a backup pipe tool device.

13. The pipe tool device of claim 1 further comprising a plurality of indicia.

14. A pipe tool device for loosening or tightening a hard-to-reach pipe, the pipe tool device comprising:
a drill attachment component comprising a gap ring component and a slip die component secured around the hard-to-reach pipe; and
a drill bit shaft secured to the drill attachment component;
wherein the drill attachment component is secured to a drill via the drill bit shaft;
wherein the slip die component comprises at least three sidewalls configured in a C-shape and a plurality of gear components that provide a clockwise or counterclockwise rotation of the slip die component, which is tangential to rotation of the drill bit shaft, thereby allowing the slip die component to tighten or loosen the hard-to-reach pipe its secured around; and
further wherein the gap ring component is positioned on an interior of the at least three sidewalls of the slip die component and engages the plurality of gear components within the slip die component to create rotation, such that the gap ring component rotates counterclockwise or clockwise to tighten or loosen the hard-to-reach pipe.

15. The pipe tool device of claim 14, wherein the gap ring components are sized and configured to be replaced with a plurality of circular blades to create a pipe cutting tool.

16. The pipe tool device of claim 14 further comprising a release trigger for releasing the pipe tool device from the hard-to-reach pipe.

17. The pipe tool device of claim 14 further comprising a support beam component having a counter torque.

18. The pipe tool device of claim 14 further comprising a backup attachment insert slot for accepting a backup pipe tool device.

19. A method of tightening or loosening a pipe in a limited space, the method comprising the steps of:
providing a pipe tool device comprising a drill attachment with a gap ring component and a slip die component to allow for tightening or loosening of the pipe in the limited space;
securing the pipe tool device to a standard drill;
securing the slip die component of the pipe tool device to the pipe to be tightened or loosened; and
activating the pipe tool device via the standard drill, such that the pipe tool device rotates in a clockwise or counterclockwise direction for tightening or loosening applications.

20. The method of claim 19 further comprising a step of utilizing a pipe cutter function of the pipe tool device to cut a pipe.
